(19) United States
(12) Patent Application Publication
(10) Pub. No.: US 2015/0227616 A1
(43) Pub. Date: Aug. 13, 2015

(54) NON-TRANSITORY COMPUTER READABLE MEDIUM, INFORMATION RETRIEVING APPARATUS, AND INFORMATION RETRIEVING METHOD

(71) Applicant: FUJI XEROX CO., LTD., Tokyo (JP)

(72) Inventor: Hiroshi UMEMOTO, Kanagawa (JP)

(73) Assignee: FUJI XEROX CO., LTD., Tokyo (JP)

(21) Appl. No.: 14/698,277

(22) Filed: Apr. 28, 2015

Related U.S. Application Data
(63) Continuation of application No. PCT/JP2013/065807, filed on Jun. 7, 2013.

(30) Foreign Application Priority Data
Nov. 12, 2012 (JP) 2012-248067

(51) Int. Cl. G06F 17/30

(52) U.S. Cl. CPC G06F 17/30598; G06F 17/30864; G06F 17/3053

(57) ABSTRACT

A non-transitory computer readable medium stores a program causing a computer to execute a process including receiving input of a character for searching search-target information, searching, on a basis of the received character, an attribute value associated with the search-target information, and outputting, as a result of a search, a content of a matching attribute value and a degree of relevance between the received character and the content of the matching attribute value, as a list for each attribute value corresponding to the received character.

### CROSS-REFERENCE TO RELATED APPLICATIONS

This application is based on and claims priority under 35 USC 119 from PCT International Application No. PCT/JP2013/065807 filed Jun. 7, 2013.

### BACKGROUND

### Technical Field

The present invention relates to a non-transitory computer readable medium, an information retrieving apparatus, and an information retrieving method.

### SUMMARY

According to an aspect of the invention, there is provided a non-transitory computer readable medium storing a program causing a computer to execute a process including receiving input of a character for searching search-target information, searching, on a basis of the received character, an attribute value associated with the search-target information, and outputting, as a result of a search, a content of a matching attribute value and a degree of relevance between the received character and the content of the matching attribute value, as a list for each attribute value corresponding to the received character.

### BRIEF DESCRIPTION OF THE DRAWINGS

Exemplary embodiments of the present invention will be described in detail based on the following figures, wherein:

FIG. 1 is a block diagram illustrating an example of a configuration of an information retrieving apparatus;

FIG. 2 is a schematic diagram illustrating an example of a configuration of attribute information;

FIG. 3 is a schematic diagram illustrating an example of a configuration of a search screen displayed on a display;

FIG. 4 is a schematic diagram illustrating an example of a configuration of a search screen displayed on the display after a search string is input;

FIG. 5 is a schematic diagram illustrating an example of a configuration of a search screen displayed on the display after an additional search string is input; and

FIG. 6 is a flowchart for explaining an example of operation of the information retrieving apparatus.

### DETAILED DESCRIPTION

### Configuration of Information Retrieving Apparatus

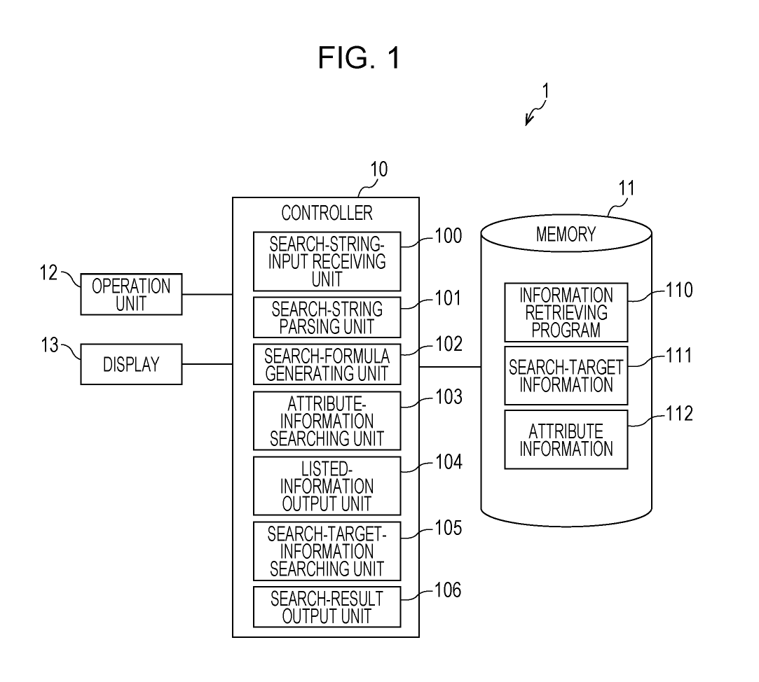

FIG. 1 is a block diagram illustrating an example of a configuration of an information retrieving apparatus 1.

The information retrieving apparatus 1 includes a controller 10, a memory 11, an operation unit 12, and a display 13 such as a liquid crystal display. The controller 10 includes a central processing unit (CPU) and the like, controls components, and executes various programs. The memory 11 includes a recording medium such as a hard disk drive (HDD) or a flash memory, exemplifying a storage device in which information is stored. The operation unit 12 includes a keyboard, a touch panel, and the like for an inputting operation.

The controller 10 executes an information retrieving program 110 (described later) to thereby function as a search-string-input receiving unit 100, a search-string parsing unit 101, a search-formula generating unit 102, an attribute-information searching unit 103, a listed-information output unit 104, a search-target-information searching unit 105, a search-result output unit 106, and the like.

The search-string-input receiving unit 100 receives a search string that is input via operation unit 12. Although the search string may be a word, a case where a natural sentence is input will be described in the present exemplary embodiment.

The search-string parsing unit 101 performs morphological analysis on the search string received by the search-string-input receiving unit 100 and extracts a keyword, a date-and-time designation expression, a logical operation expression, and the like.

The search-formula generating unit 102 generates a search formula on the basis of a result of the parsing performed by the search-string parsing unit 101. How to generate the search formula will be described later.

The attribute-information searching unit 103 searches attribute information 112 for a category and a keyword by using the search formula generated by the search-formula generating unit 102, the attribute information 112 being attribute values of search-target information 111.

The listed-information output unit 104 outputs to the display 13 a result of a search performed by the attribute-information searching unit 103, as listed information including the category, the keyword, the number of retrieved information pieces, and the like.

The search-target-information searching unit 105 searches the search-target information 111 by using the search formula generated by the search-formula generating unit 102.

The search-result output unit 106 outputs to the display 13 documents and the like retrieved from the search-target information 111, as a result of a search performed by the search-target-information searching unit 105.

The information retrieving program 110, the search-target information 111, the attribute information 112, and the like are stored in the memory 11.

The information retrieving program 110 is a program causing the controller 10 to operate as the aforementioned units 100 to 106.

The search-target information 111 is information to be searched by the search-target-information searching unit 105 and is document information including text information, image information, audio information, moving image information, and the like. The type of information is not particularly limited.

The attribute information 112 includes attribute values each associated with a piece of search-target information 111. One or multiple keywords are registered in advance in each of the categories.

Note that the information retrieving apparatus 1 is, for example, a personal computer. A mobile phone, a tablet terminal, or the like may also be used.

In addition, the controller 10 and the memory 11 may form a server apparatus in which the operation unit 12 and the display 13 are not included, the server apparatus operating in response to a request from an external terminal.

In addition, multiple server apparatuses may be used to form the controller 10 and the memory 11, the server apparatuses operating in response to a request from an external terminal.

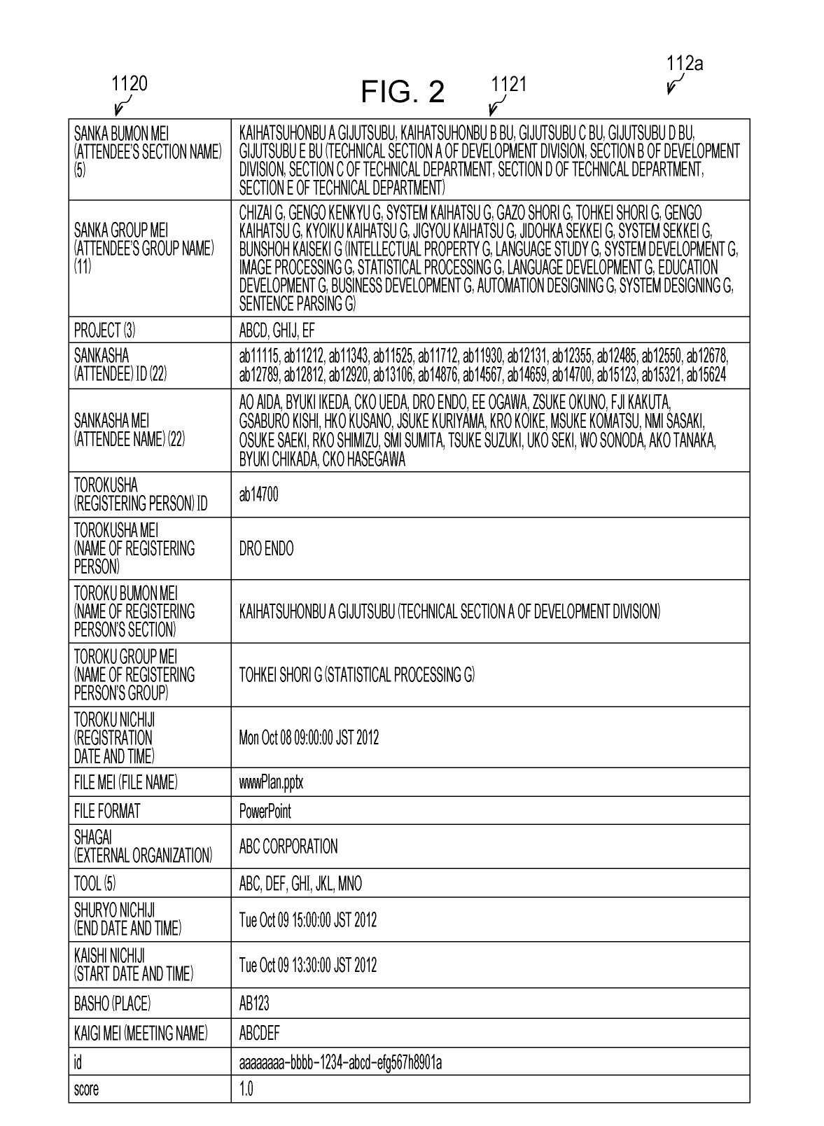

FIG. 2 is a schematic diagram illustrating an example of a configuration of the attribute information 112.

Attribute information 112a has multiple categories 1120, and keywords 1121 are registered in the categories 1120. Note that one or multiple keywords 1121 are registered in each category 1120.

### Operation of Information Retrieving Apparatus

Next, effects of the present exemplary embodiment will be described separately for (1) a basic operation, (2) a search preparation operation, and (3) a search operation.

### (1) Basic Operation

A user of the information retrieving apparatus 1 first registers multiple pieces of search-target information 111 in the memory 11 by using the information retrieving apparatus 1 or an external information processing apparatus and registers pieces of attribute information 112 in association with the respective pieces of search-target information 111.

### (2) Search Preparation Operation

Next, the user of the information retrieving apparatus 1 operates the information retrieving apparatus 1 via operation unit 12 to search the search-target information 111 registered in advance for a desired information piece.

In response to the user operation, the information retrieving apparatus 1 displays a search screen 130a for searching the search-target information 111 (described below).

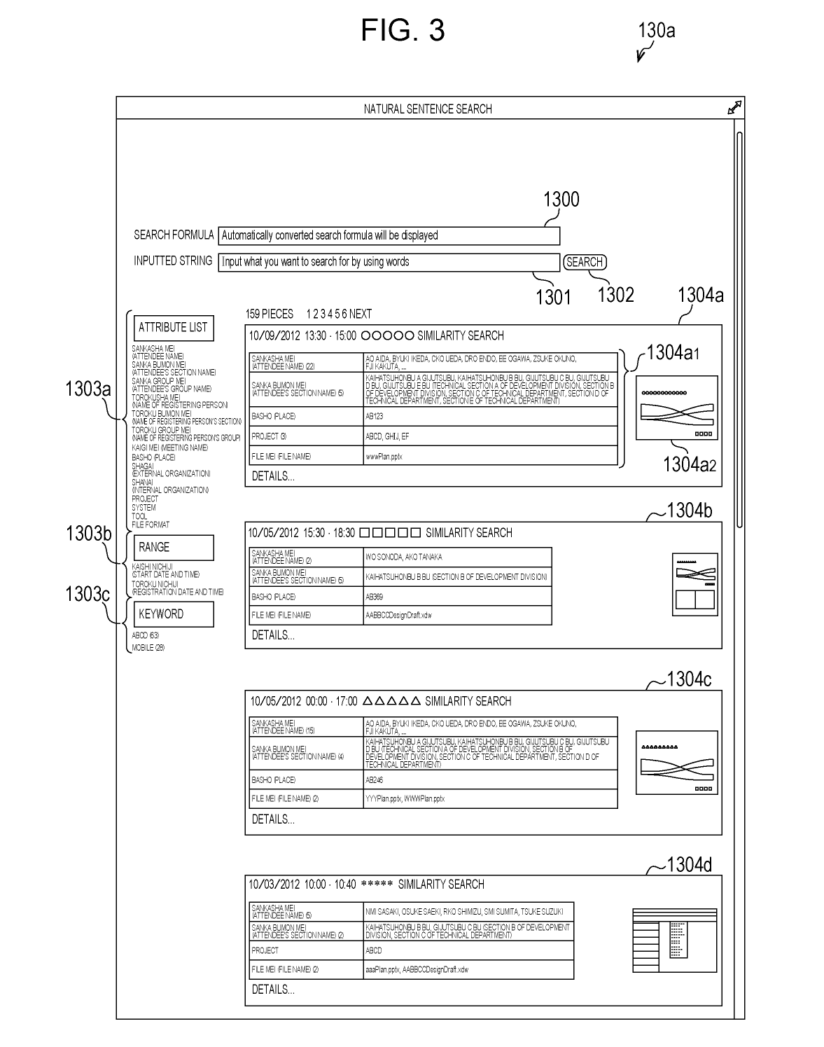

FIG. 3 is a schematic diagram illustrating an example of a configuration of the search screen 130a displayed on the display 13.

The search screen 130a has a search-formula input field 1300 for inputting a search formula, a search-string input field 1301 for inputting a search string, a search button 1302 for executing searching of the search-target information 111, category displaying regions 1303a to 1303c in which category names in the attribute information 112 are listed and displayed, and search-result displaying regions 1304a to 1304d in which the attribute information 112 corresponding to the search-target information 111 retrieved as a result of a search is partially displayed in a simplified manner.

The user operates the operation unit 12 to input a search string in a search-string input field 1301 on the search screen 130a.

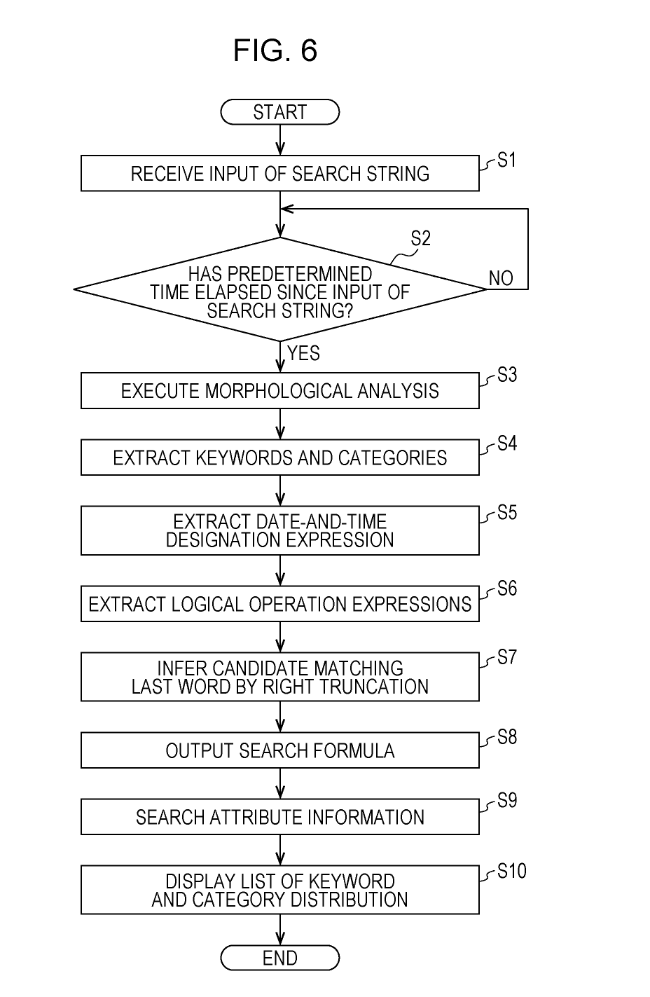

FIG. 6 is a flowchart for explaining an example of operation of the information retrieving apparatus 1.

The search-string-input receiving unit 100 of the information retrieving apparatus 1 receives input of a search string in response to a user operation (S1).

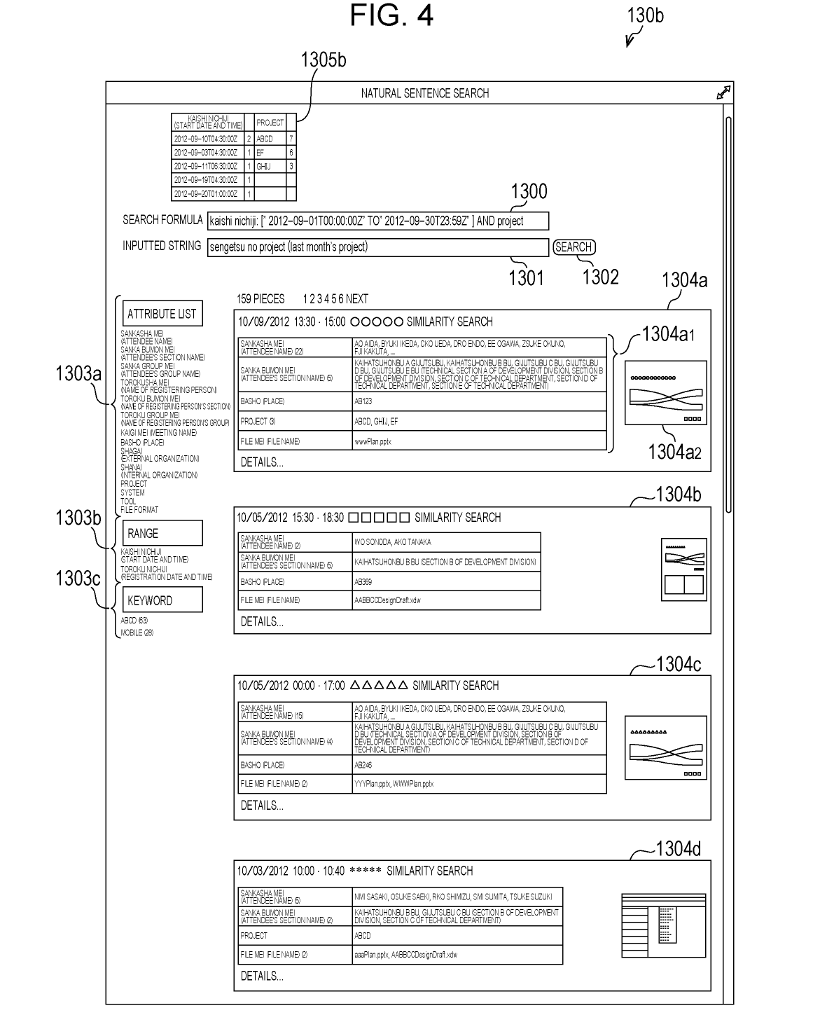

FIG. 4 is a schematic diagram illustrating an example of a configuration of a search screen 130b displayed on the display 13 after the search string is input.

As illustrated in FIG. 4, upon inputting “sengetsu no project” (last month's project) into the search-string input field 1301, the search-string-input receiving unit 100 receives the text.

Next, if a predetermined time of, for example, one second elapses after input of the search string (S2; YES), the search-string parsing unit 101 performs a morphological analysis on the search string “sengetsu no project” (S3), extracts “project” as a category (S4), and extracts “sengetsu” (last month) as a date-and-time designation expression (S5). Note that when the morphological analysis is performed, the search-string parsing unit 101 extracts in advance as words categories and keywords included in the attribute information 112. If any matching word exists, the word is utilized and assigned a part of speech.

Note that inputting a further search string into the search-string input field 1301 leads to another search screen as described below.

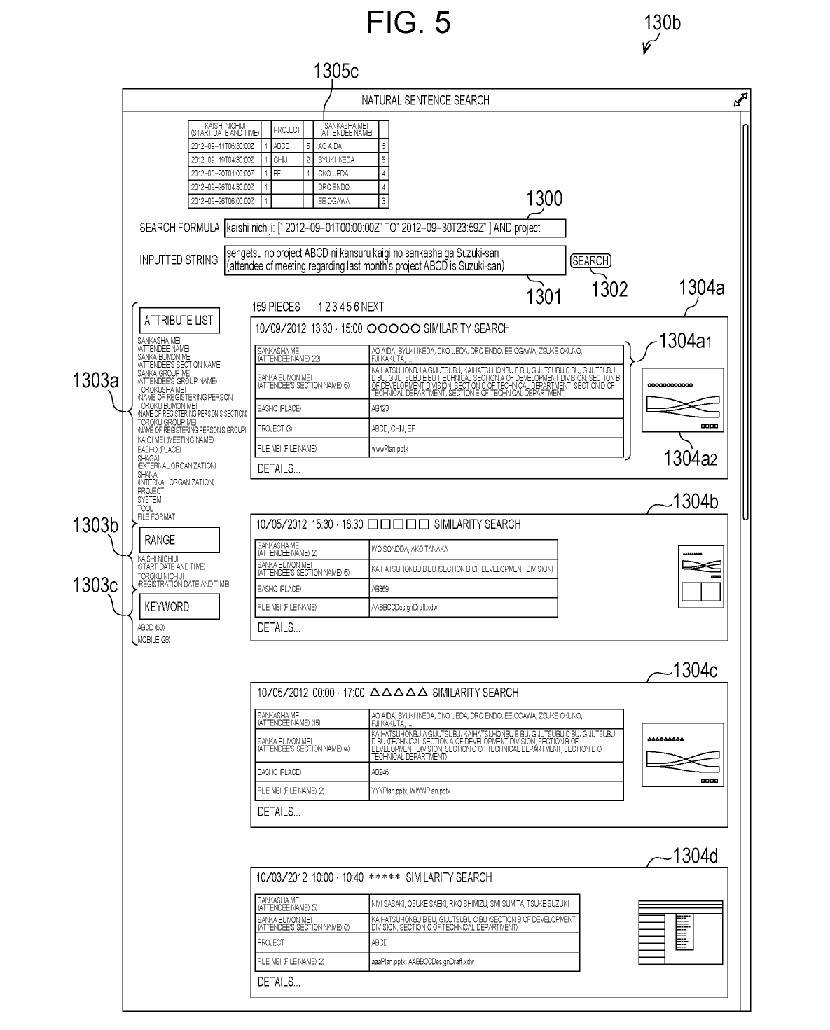

FIG. 5 is a schematic diagram illustrating an example of a configuration of a search screen 130c displayed on the display 13 after an additional search string is input.

As illustrated in FIG. 5, upon inputting “sengetsu no project ABCD ni kansuru kaigi no sankasha ga Suzuki-san” (an attendee of a meeting regarding last month's project ABCD is Suzuki-san) into the search-string input field 1301, the search-string-input receiving unit 100 receives the text.

From the search string, the search-string parsing unit 101 extracts “project”, “kaigi” (meeting), and “sankasha” (attendee) as categories and “ABCD” and “Suzuki-san” as keywords (S4).

The search-string parsing unit 101 also extracts “no”, “ni kansuru” and “ga” as logical operation expressions (S6).

In addition, for example, in a case where the search string is incompletely input as “sengetsu no pro”, the search-string-input receiving unit 100 infers as a candidate a category or a keyword that matches the last word “pro” by right truncation (S7). In this case, “project” exists in category names, and thus the search-string-input receiving unit 100 infers “project” from “pro”. The inferred word is processed in steps S3 to S6.

Next, the search-formula generating unit 102 generates a search formula by using the keywords, the categories, the date-and-time designation expression, and the logical operation expressions that are extracted in steps S4 to S7 described above and outputs the search formula (S8).

In the example described above, the search formula is generated in the following manner. In a case where the current month is October 2012, ‘kaishi nichiji: [“2012-09-01T00:00:00Z” TO “2012-09-30T23:59:59Z”]’ (kaishi nichiji means start date and time) is generated from the date-and-time designation expression “sengetsu”. In addition, ‘project: “ABCD”’ is generated from the category “project” and the keyword “ABCD”, ‘sankashamei: “Suzuki”’ (sankashamei means the name of an attendee) is generated from a category “sankashamei” and the keyword “Suzuki-san”, and “AND” serving as the logical operation expression is used for “no”, “ni kansuru”, and “ga” to connect the words.

In addition, as the logical operation expression, “OR” is generated from “matawa” (or) and the like, and “NOT” is generated from “dewanai” (not) and the like. Moreover, in a case where a person's name such as “Sato-san” is input, the category is “sankasha”. However, in a case where “Sato-san ga tsukutta” (Sato-san made) is input, the category may be “tourokusha” (registering person) in consideration of the context “ga tsukutta”.

Next, the attribute-information searching unit 103 performs a search to retrieve a piece of search-target information 111 by using each category and the keyword belonging to the category on the basis of the search formula (S9). The attribute-information searching unit 103 displays, on the search screen 130b or 130c, listed information 1305b or 1305c illustrated in FIG. 4 or FIG. 5 as well as the number of information pieces matching as a result of searching (S10).

In the listed information 1305b illustrated in FIG. 4, the number of information pieces matching a keyword “2012-09-10 TO 04:30:00Z” in the category “kaishi nichiji” is “2”, the number of information pieces matching a keyword “2012-09-03 TO 04:30:00Z” is “1”, the number of information pieces matching a keyword “2012-09-11 TO 06:30:00Z” is “1”, the number of information pieces matching a keyword “2012-09-19 TO 04:30:00Z” is “1”, and the number of information pieces matching a keyword “2012-09-20 TO 01:00:00Z” is “1”.

In addition, the number of information pieces matching the keyword “ABCD” in the category “project” is “7”, the number of information pieces matching a keyword “EF” is “6”, and the number of information pieces matching a keyword “GHIJ” is “3”.

The listed information 1305c illustrated in FIG. 5 exhibits changes in comparison with the listed information 1305b illustrated in FIG. 4, because an additional string is input. The number of information pieces matching the keyword “2012-09-11 TO 06:30:00Z” in the category “kaishi nichiji” is “1”, the number of information pieces matching the keyword “2012-09-19 TO 04:30:00Z” is “1”, the number of information pieces matching the keyword “2012-09-20 TO 01:00:00Z” is “1”, the number of information pieces matching a keyword “2012-09-26 TO 04:30:00Z” is “1”, and the number of information pieces matching a keyword “2012-09-26 TO 06:00:00Z” is “1”.

There are also changes in which the number of information pieces matching the keyword “ABCD” in the category “project” is “5”, in which the number of information pieces matching the keyword “GHIJ” is “2”, and in which the number of information pieces matching the keyword “EF” is “1”.

Further, “sankashamei” is added as a category, the number of information pieces matching a keyword “Ao Aida” is “5”, the number of information pieces matching a keyword “Byuki Ikeda” is “5”, the number of information pieces matching a keyword “Cko Ueda” is “4”, the number of information pieces matching a keyword “Dro Endo” is “4”, and the number of information pieces matching a keyword “Ee Ogawa” is “3”.

The user may also correct the input string on the basis of the attribute information displayed as the listed information 1305c. For example, after “Suzuki-san” input into the search-string input field 1301 is corrected as “Ikeda-san”, a search may be performed to retrieve a piece of search-target information 111.

Note that steps S1 to S10 described above are executed every time the content of a text input into the search-string input field 1301 is updated in such a manner that a deletion, addition, or the like is made to the string. In other words, every time the user updates the text input into the search-string input field 1301, the search formula in the search-formula input field 1300 is updated, and the content of the listed information 1305b or 1305c is updated in accordance with a result of searching the attribute information 112 by using the search formula.

### (3) Search Operation

The user checks the listed information 1305b or 1305c, changes the search string as necessary, and clicks the search button 1302.

The search-target-information searching unit 105 of the information retrieving apparatus 1 searches the search-target information 111 on the basis of the search formula generated from the input final search string, and the search-result output unit 106 displays a retrieval result on the display 13.

### Other Exemplary Embodiments

Note that an exemplary embodiment of the invention is not limited to the exemplary embodiment described above, and various modifications may be made without departing from the spirit of the invention. Although the information retrieval using, for example, the Japanese language has been described, the exemplary embodiment of the invention is applicable to information retrieval using other languages.

Although the functions of the units 100 to 106 in the controller 10 are implemented by the program in the exemplary embodiment described above, all or some of the units may be implemented by hardware such as an ASIC. In addition, the program used in the exemplary embodiment described above may also be provided, being stored on a recording medium such as a CD-ROM. Moreover, mutual changes, deletions, additions, and the like of steps described above in the aforementioned exemplary embodiment may be made without departing from the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process comprising:
receiving input of a character for searching search-target information;
searching, on a basis of the received character, an attribute value associated with the search-target information; and
outputting, as a result of a search, a content of a matching attribute value and a degree of relevance between the received character and the content of the matching attribute value, as a list for each attribute value corresponding to the received character.

2. The non-transitory computer readable medium according to claim 1, wherein
each of the attribute values has, as the content, a plurality of categories and keywords each associated with one of the plurality of categories, and
a list of the number of information that matches each keyword is output as the degree of relevance on a per category basis.

3. The non-transitory computer readable medium according to claim 2, wherein
the attribute value includes the search-target information as the category and includes the content of the search-target information as the keyword associated with the category representing the search-target information.

4. The non-transitory computer readable medium according to claim 2, wherein
a natural sentence is received as the character, and
the category in the attribute value is changed in accordance with context of the natural sentence.

5. The non-transitory computer readable medium according to claim 3, wherein
a natural sentence is received as the character, and
the category in the attribute value is changed in accordance with context of the natural sentence.

6. The non-transitory computer readable medium according to claim 1, the process further comprising:
searching the search-target information on a basis of the received character.

7. The non-transitory computer readable medium according to claim 2, the process further comprising:
searching the search-target information on a basis of the received character.

8. The non-transitory computer readable medium according to claim 3, the process further comprising:
searching the search-target information on a basis of the received character.

9. The non-transitory computer readable medium according to claim 4, the process further comprising:
searching the search-target information on a basis of the received character.

10. The non-transitory computer readable medium according to claim 5, the process further comprising:
searching the search-target information on a basis of the received character.

11. An information retrieving apparatus comprising:
a receiving unit that receives input of a character for searching search-target information;
a generating unit that generates, on a basis of the character received by the receiving unit, a search formula for searching an attribute value associated with the search-target information;
an attribute information searching unit that searches the attribute value on a basis of the search formula generated by the generating unit; and
an output unit that outputs, as a result of a search performed by the attribute information searching unit, a content of a matching attribute value and a degree of relevance between the search formula and the content of the matching attribute value, as a list for each attribute value corresponding to the character received by the receiving unit.

12. An information retrieving method comprising:
receiving input of a character for searching search-target information;
searching, on a basis of the received character, an attribute value associated with the search-target information; and
outputting, as a result of a search, a content of a matching attribute value and a degree of relevance between the received character and the content of the matching attribute value, as a list for each attribute value corresponding to the received character.
